(19) United States
(12) Patent Application Publication
(10) Pub. No.: US 2011/0276521 A1
(43) Pub. Date: Nov. 10, 2011

(54) System and method for monetizing content

(76) Inventors: Patrick A. Grotto, Chicago, IL (US); Joseph T. Miotke, Shorewood, WI (US)

(21) Appl. No.: 12/799,864

(22) Filed: May 4, 2010

(51) Int. Cl. G06Q 90/00

(52) U.S. Cl. 705/500

(57) ABSTRACT

A system and method for generating revenue from copyrighted information and other content. The content is selected, and the ownership and other permissions needed to generate revenue from this content is then cleared. A liquidity event for the content, such as a public auction, is provided. A distributed computer system is provided for carrying out the revenue generating methodology.

### CROSS-REFERENCES TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### BACKGROUND OF THE INVENTION

### Field of the Invention

The present invention relates to generating revenue from copyrighted information and other content and more specifically to a system and method for monetizing copyrighted information and other content.

### BRIEF SUMMARY OF THE INVENTION

In recent times, intellectual property (“IP”) has emerged as a new asset class with substantial value. In its common understanding, IP encompasses patents, trademarks, copyrights, and trade secrets. Unlocking revenues associated with this highly valuable new asset class presents unique challenges for each distinct type of IP. IP auctions have emerged as one vehicle for monetizing IP, and each distinct type of IP involves unique challenges in connection with the auction or other vehicle to monetize the IP. For example, patents often require substantial due diligence prior to the monetization transaction in order to more fully understand the scope of the patent coverage and identify any potential matters that might impact the strength or value of the patent. As another example, and pertinent to the present invention, copyrighted content often involves multiple tiers of ownership and other interests in the content, making a monetization transaction somewhat challenging as these multiple interests are assessed and addressed prior to the transaction. Without the proper process to prepare for a monetization transaction involving copyrighted content or other information, uncertainty can exist in the marketplace as to whether the copyrighted content or other information is appropriate for the transaction.

The present invention overcomes the current limitations and uncertainty in the marketplaces by providing a system and process through which copyrighted information and other information can be used to generate revenue, also referred to as monetization. The invention provides a process for validating and transforming the tangible value of copyrighted music, video, print, photos, some in archived or other types of collections, into a tangible financial asset for a liquidity event such as a sale. This transformation enables the value of this IP to be unlocked and occurs through following the steps outlined herein. These steps provide a method of assuring the ownership, validity, and provenance of the IP asset of interest.

In another aspect, the present invention provides a system for validating and transforming the value of content into a tangible asset for a liquidity event. The system offers remote access by appropriate users as needed and is scalable to meet the needs of any liquidity event.

### BRIEF DESCRIPTION OF THE SEVERAL VIEWS OF THE DRAWINGS

FIG. 1 provides a flow diagram of the steps carried out according to certain aspects of the invention for monetizing copyrighted information.

FIG. 2 provides a block diagram of a system for use in carrying out the various steps of the present invention in a collaborative fashion.

The drawings are shown for illustrative purposes only and are not intended to limit the scope of the claimed invention.

### DETAILED DESCRIPTION OF THE INVENTION

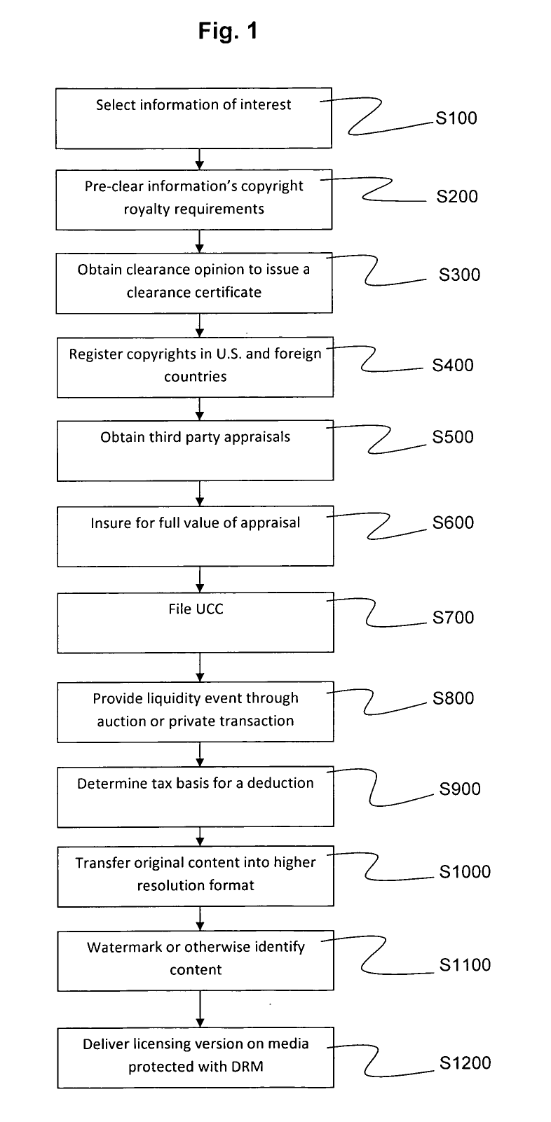

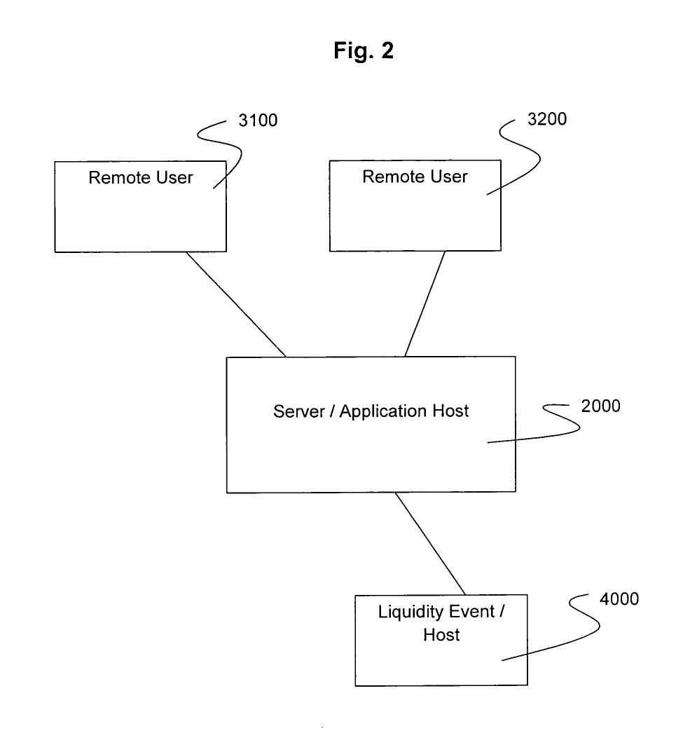

The present invention provides a system and method for generating revenue from, or monetizing, copyrighted and other information, referred to collectively herein as “content.” These steps are depicted in FIG. 1. In another aspect of the present invention, a system in the form of a computer server or other digital device in communication with local or remote users is used to facilitate the content monetization and enable collaboration throughout various stages of the monetization process. One way of implementing the architecture of this system is depicted in FIG. 2.

The individual steps of the present invention, and use of a computer system in connection with these steps, are now described in detail. Unless expressly indicated or claimed, such steps are not required to be carried out in a specific order. In addition, it should be understood that the content of this patent application should not be construed as providing any form of legal advice and that any entity involved in monetizing content as described herein should seek legal advice from a qualified attorney.

Selecting Content of Interest

Referring to FIG. 1, the typical initial step of the present invention is step S100, in which the content of interest is selected. There are many forms of content that can be monetized, and such content forms include music recordings (both live and studio, and audio and audio/video), theatrical performances (both audio and video), any form of audio recording, any form of video recording, and text-based content such as books, articles, essays, news reports. Typically such content is protected by U.S. or other copyright laws, but such copyright protection or registration is not a requirement when selecting the content for monetization.

In one aspect of the invention, content is selected because it has the potential to generate licensing revenue through online downloading, streaming, or other digital delivery methods. Of course, conventional, non-digital delivery methods such as U.S. mail and private delivery services such as UPS or Federal Express could also be used. Examples of such content include audio/video recordings of rare concerts by popular performing or recording artists and audio, video, or audio/video recordings of historic events. The present invention is not limited to any specific type of content and can be utilized in connection with a wide variety of content formats suitable for subsequent digital or other forms of delivery.

Referring to FIG. 2, as content is selected for potential monetization, such content can be stored digitally on a server or application host 2000. Server or application host 2000 is not limited to any specific form of computer hardware or software and can be any suitable hardware or software component appropriate for data storage and application hosting that is accessible by remote users 3100 and 3200. The present system is not limited to use by only remote users 3100 and 3200, which are shown for illustration only, and can be accessed by as many remote users as needed. Such architecture can include conventional server/client computer architecture or “cloud computing” architecture in which data and software applications are stored and hosted remotely from the users 3100 and 3200.

Copyright and Other Clearance

After the content of interest is selected in step S100, the ownership rights in the content typically are investigated and assessed to ensure that proper ownership rights, licenses, and other permissions can be obtained prior to monetizing the content. This is shown as step S200 in FIG. 1. This investigation and assessment is important to properly monetize the content because without such clearance, an entity claiming ownership or other rights in the content could derail efforts to monetize the content through a lawsuit or other methods. Investigating, assessing, and obtaining the ownership rights, licenses, and other permissions needed to monetize the content is referred to herein as “clearing” or “obtaining clearance” for the content. The type of clearance needed will depend upon the type of content that is being monetized. During this clearance step S200, all rights, licenses, and other permissions necessary to monetize the content typically are obtained.

Referring to FIG. 2, as the clearance is conducted, the documents and other information gathered in connection with the clearance investigation can be stored on server/application host 2000 so that such information is readily accessible by others such as remote users 3100 and 3200 that might be participating in the investigation.

Obtain Clearance Opinion to Issue Clearance Certificate

After the content has been cleared in step S200, a clearance opinion typically is obtained from an intellectual property attorney or other attorney qualified to render such an opinion, show in FIG. 1 as step S300. In the clearance opinion, the intellectual property attorney typically reviews the ownership rights, licenses, and other permissions obtained during the clearance step S200 to assess the likelihood of any potential problems that might arise when the content is monetized. Rather than simply spotting issues and problems, the IP attorney typically will offer solutions to any identified problems and assist in obtaining any outstanding rights that might be needed to monetize the content. Once all necessary rights and permissions have been obtained, the IP attorney will issue a clearance opinion stating that it is the attorney's opinion that all needed rights and permissions necessary for monetization of the IP have been obtained. Such an opinion does not insure or guarantee that a third party will not subsequently file a lawsuit or initiate other action alleging ownership rights in the content, or otherwise challenge the content monetization, as the attorney has no control over the actions of the third parties. Indeed, in other intellectual property contexts such as those involving patents, patent infringement lawsuits are commonly filed against companies that have already obtained opinions from IP attorneys indicated that the product of interest does not infringe the subject patent.

Once the clearance opinion is obtained, a clearance certificate can be issued. This clearance certificate is tantamount to a representation and warranty that all necessary rights and permissions have been obtained prior to monetizing the content. The party issuing this certificate must be prepared to defend against any subsequent challenges regarding the ownership, licenses, or permissions surrounding the content, and a reserve fund set aside to oppose such challenges would be advisable. In certain circumstances, the purchaser of the content might require assurances that such a fund is maintained at appropriate levels for a specified duration of time.

Referring to FIG. 2, the clearance opinion can also be stored on the server/application host 2000. Access to the server/application host should be restricted to the parties that sought the opinion, however, in order to preserve any applicable privileges such as the attorney-client privilege. The clearance certificate also could be stored on the server/application host 2000.

Register Copyrights in the United States & Elsewhere

At some point prior to monetization, and typically after the clearance opinion is obtained, the copyright in the content should be registered with the U.S. Copyright Office as shown in step S400 in FIG. 1. While copyright registration is not required in the United States to enjoy many copyright protections, registration offers added benefits in the United States and is generally a prerequisite to filing a copyright infringement lawsuit in the United States. In addition, copyright registration should be obtained in other countries where the monetized content will be used to generate revenue. Moreover, the copyright registration should be obtained in countries where there is a possibility that the content will be pirated. Such countries commonly include China, Taiwan, South Korea, and India. An intellectual property attorney will be able to assist in obtaining the appropriate copyright registrations.

The copyright registration information can be stored on server/application host 2000 and accessed by remote users 3100 and 3200 as appropriate.

Obtain Third Party Appraisals

Third party appraisals for the copyright typically are obtained, as shown in step S500. Such third party appraisals serve as the baseline for subsequent monetizing efforts and also provide the basis for insuring the asset.

The third party conducting the appraisal of step S500 can be given limited access to server/application host 2000 for access to the information and documents stored therein that would be helpful in the appraisal. Such information could include the content itself, the clearance certificate, and the documentation supporting the clearance certificate.

Obtain Insurance

Once the value of the content has been appraised, insurance should be obtained for the full value of the appraisal, as shown in step S600. Such insurance protects against the destruction or loss of the content before, during, or after monetization.

The insurance documentation and related insurance information can be stored on server/application host 2000 and accessed by remote users 3100 and 3200 as appropriate.

File UCC Documents

In certain instances, uniform commercial code (“UCC”) documents such as financing statements or other documents necessary to perfect a lien interest might be filed in connection with the content, as shown in step S700. Such UCC documents provide added security and comfort in connection with the monetization process, similar to how such UCC filings are used in conventional business transactions involving tangible assets.

The UCC documents and other information can be stored on server/application host 2000 and accessed by remote users 3100 and 3200 as appropriate.

Provide Liquidity Event

Central to monetizing the content is providing a liquidity event, shown as step S800 in FIG. 1. Common liquidity events include selling the content and its associated rights at a public auction or otherwise selling the content and associated rights though a privately brokered transaction. The ICAP Ocean Tomo intellectual property auction is one example of a public auction at which the content and its associated rights can be sold. The ICAP Ocean Tomo IP auction is a good vehicle for such a liquidity event because this auction is widely known for its IP transactions. The public auction is a good vehicle for a liquidity event for a variety of reasons, including the transparency in bidding on the content. In certain instances, a privately brokered transaction might be preferred. These instances include situations where the purchasers want an added level of anonymity or the transaction includes unique terms and conditions that are not appropriate for negotiation on the auction floor.

Referring to FIG. 2, server/application host 2000 can be utilized to support the liquidity event of step S800. A “virtual” due diligence room could be implemented on server/application host 2000, and parties interested in acquiring the content could login to this due diligence room as remote users 3100 or 3200 and review documents and other information needed for the due diligence process. Such interested parties typically would be required to sign nondisclosure agreements or agree to similar confidentiality obligations prior to reviewing the information residing in the due diligence room. Information stored in the due diligence room typically would include the content itself, the documentation associated with the clearance investigation, and the clearance certificate.

Again referring to FIG. 2, a liquidity event host 4000 could be used to host an online auction or otherwise support a transaction using online collaboration techniques. While liquidity event host 4000 is shown as a separate component in FIG. 2, liquidity event host 4000 could be included as part of the functionality included with server/host application 2000.

Determine Tax Basis for Deduction

Typically following the liquidity event of step S800, or at any other appropriate time, the tax basis of the content for a tax deduction will be determined, shown as step S900 in FIG. 1. The tax basis for a tax deduction will commonly be determined by a tax specialist such as an accountant or tax attorney. This tax basis becomes especially important when the content is donated to a non-profit entity, in which case the entity making the donation can tax a tax credit in the form of a deduction as a result of the donation. Of course, care must be taken to ensure that such a tax credit and deduction is appropriate under the circumstances, and the involvement of a tax professional such as an accountant or tax attorney is advisable.

Referring to FIG. 2, information needed to make the tax basis determination of step S900 could be stored on server/application host 2000 and accessed by remote users 3100 and 3200 as appropriate.

Transfer Original Content into Higher Resolution Format

Either prior to the liquidity event, or after such event as shown in FIG. 1, the original content is transferred onto a higher resolution format, shown as step S1000. In the case of video recordings, analog video recordings or lower-resolution video recordings, the content is transferred into higher-resolution formats such as 1,080 pixel high-definition formats. The transfer onto a high resolution format makes the content more appealing for subsequent downloading by end users. Of course, this transfer is not limited to 1080 pixel formats, as any other suitable high resolution format is appropriate as well. In certain instances, it will be preferable to make the transfer onto a higher resolution format prior to the liquidity event because this will potentially increase the revenue generated by the liquidity event.

Referring to FIG. 2, the higher resolution content can be stored on server/application host 2000 and accessed by remote users 3100 and 3200 as appropriate. Such access typically is not granted until after steps S1100 and S1200 as described below, however, because of security and piracy concerns.

Watermark or Otherwise Identify Content

The content should be “watermarked” or otherwise identified so that the identity of the content can be easily verify in the event of pirating or other unlicensed or unpermitted used of the content. The watermarking step is shown as step S1100 in FIG. 1. It should be understood that watermarking step S1100 can occur at any time during the described process. A watermark is typically a digital indicator embedded into the content that serves to uniquely identify the content. Such watermarks are one form of digital rights management (“DRM”) tools that are used to protect the ownership and integrity of the content. As one example of watermarking content, an audio signal is embedded in the vertical blanking interval (“VBI”) of the content, which serves as a unique identifier of the content. Using watermarks or other DRM tools is advisable because provisions of the Digital Millennium Copyright Act (“DMCA”) prohibit the removal of such DRM tools from content and provide civil and criminal penalties for doing so. The inclusion of such DRM tools in the content also tends to improve the revenue generate during the liquidity event because it is one less task for the purchaser of the content.

Deliver Content on Media Protected with DRM

The content should be delivered on a media that includes features to minimize or eliminate the likelihood of unpermitted or unlicensed use of the content, and this step is shown as step S1200 in FIG. 1. As one example, the content could be delivered on a master CD or DVD that derogates after three to five plays to minimize the likelihood of piracy or other unauthorized uses. As with many of the other steps in the invention, step S1200 can occur at a variety of times, but preferably is completed before the content is delivered to another party.

Referring to FIG. 2, the content could alternatively be stored on server/application host 2000 and delivered using a secure environment such as an encrypted file transfer protocol or other secure transfer means. The content delivered using server/application host 2000 could likewise employ DRM functions to preclude unauthorized distribution or copying of the content.

Those skilled in the art will appreciate that numerous modifications and variations may be made to the above disclosed embodiments without departing from the spirit and scope of the present invention.

1. A method for generating revenue comprising the steps of:
selecting content;
obtaining ownership and permissions needed to generate revenue from the content; and
providing a liquidity event for the content.

2. The method of claim 1 wherein the content is an audio music recording.

3. The method of claim 1 wherein the content is an audio/video music recording.

4. The method of claim 4 wherein the content is a recording of a live performance.

5. The method of claim 1 wherein the liquidity event is a public auction.
